(19) United States
(12) Patent Application Publication
(10) Pub. No.: US 2025/0042679 A1
(43) Pub. Date: Feb. 6, 2025

(54) TRUSSED RAMP

(71) Applicant: Motis, LLC, Germantown, WI (US)

(72) Inventors: Robert Krolski, Kewaskum, WI (US); Carl Richter, Menomonee Falls, WI (US)

(73) Assignee: Motis, LLC, Germantown, WI (US)

(21) Appl. No.: 18/790,626

(22) Filed: Jul. 31, 2024

Related U.S. Application Data
(60) Provisional application No. 63/517,042, filed on Aug. 1, 2023.

(51) Int. Cl. B65G 69/30

(52) U.S. Cl. CPC B65G 69/30

(57) ABSTRACT

A ramp includes an extruded beam extending between a first end and a second end. The extruded beam includes a top plate and a bottom plate opposite the top plate. A first side wall and a second side wall each extend between the top plate and the bottom plate. A series of alternately angled brace walls are interior of the first and second side walls. Adjacent brace walls of the series form a series of right triangles between the top plate and the bottom plate.

### CROSS-REFERENCE TO RELATED APPLICATION

The present claims priority of U.S. Provisional Patent Application No. 63/517,042, filed on Aug. 1, 2023, which application is incorporated by reference herein in its entirety.

### FIELD

The present disclosure relates to cargo loading and transportation and specifically to ramps configured for loading and unloading trucks and trailers.

### BACKGROUND

Ramps allow vehicles and cargo to be loaded onto open or enclosed trailers. Load levelers support loads above open drop deck semi-trailers. U.S. Pat. Nos. 7,930,788 and 8,347,439 disclose examples of combination ramp and load levelers. U.S. Pat. No. 8,448,278 discloses examples of a ramp. U.S. Pat. No. 8,061,943 discloses examples of a load leveler. Each of U.S. Pat. Nos. 7,930,788; 8,061,943; 8,347,439; and 8,448,278 are incorporated herein by reference in their entireties.

U.S. Pat. No. 10,710,824, which is incorporated herein in its entirety, is entitled “Curbed Ramp” and discloses a ramp system with curb that includes an angled inner wall connected to a vertically extending outer wall. US Patent Application Publication No. 2022/0017314, which is incorporated herein in its entirety, is entitled “Combination Ramp and Load Levelers” and discloses a ramp having an extruded beam with first and second brace walls that respectively extend at angles away from interior corners of the extruded beam. US Patent Application Publication No. 2022/0017315, which is incorporated herein in its entirety, is entitled “Trussed Ramp” and discloses a ramp having an extruded beam with a center wall and side walls that extend vertically between top and bottom plates and brace walls that extend between the top plate and the bottom plate interior of the side walls and the center wall.

### BRIEF DISCLOSURE

The present application discloses improvements in ramp construction and design, and particularly the ramp construction and designs including, but not limited to those as disclosed in U.S. Pat. No. 10,710,824; US Pub. No. 2022/0017314; and US Pub. No. 2022/0017315 noted above.

Examples of a ramp include an extruded beam extending between a first end and a second end. The extruded beam includes a top plate and a bottom plate opposite the top plate. A first side wall and a second side wall each extend between the top plate and the bottom plate. A series of alternately angled brace walls are interior of the first and second side walls. Adjacent brace walls of the series form a series of right triangles between the top plate and the bottom plate.

In further examples, the first side wall includes a tongue extending lengthwise along the first side wall and outwardly away from the second side wall. The second side wall includes a groove extending lengthwise along the second side wall and interiorly towards the first side wall. The tongue is of a first dimension configured to fit within a second dimension of the groove. An arch is formed between each adjacent brace wall at respective intersections of the adjacent brace walls and the top plate or the bottom plate. The arch may be through 90° of arc. An arc is formed between each of the brace walls and the first plate or the second plate, wherein the arc forms an extended area of physical connection between the brace wall and the respective first or second plate. The arc may be through 45° of arc.

In additional examples, a curb projection extends vertically above the top plate. A curb rail includes a rail body and the curb projection extends from the rail body. The rail body includes an interior face opposite an outer face of the rail body. The interior face is configured for engagement with the first or second side wall of the extruded beam. The rail body includes a first projection and a second projection extending outward from the rail body in a direction away from the outer face The interior face is defined between the first and second projections. The interior face, first projection, and second projection are configured for engagement with the extruded beam. The top plate meets the first side wall and the second side wall at first chamfered corners. The bottom plate meets the first side wall and the second side wall at second chamfered corners. The first projection is configured to correspond to the first chambered corners. The second projection is configured to correspond to the second chamfered corners. The extruded beam may be a first extruded beam and the first chamfered corners of the first extruded beam and the first chamfered corners of a second extruded beam are configured to form a first depression between the first extruded beam and the second extruded beam. The second chamfered corners of the first and second extruded beams are configured to form a second depression between the first extruded beam and the second extruded beam. A first groove extends lengthwise along the interior face of the rail body. The first side wall includes a tongue extending lengthwise along the first side wall and outwardly away from the second side wall. The second side wall includes a second groove extending lengthwise along the second side wall and interiorly towards the first side wall. The first groove is configured to receive the tongue of the first side wall. The curb projection may be integral to the extruded beam.

In still further examples, the curb projection includes an outer face and an angled wall that joins the outer face at a curb tip. A slot extends from the curb tip at least partially through the outer face and the angled wall. The slot may be a medial slot along a midline of the curb projection and at least one lateral slot that extends from the curb tip at least partially through the outer face and the angled wall at a location between the midline and a lateral end of the curb projection. An intermediate bar extends between the outer face and the angled wall and the slot extends from the curb tip in the direction of the intermediate bar. An arcing slot may extend from the slot in a direction away from the midline and towards the intermediate bar. A return slot may extend from the arcing slot in a direction away from the midline and towards the curb tip. A transverse slot may extend perpendicularly away from the slot. A return slot may extend from the transverse slot in a direction away from the midline and towards the curb tip.

An example of a ramp includes a beam extending between a first end and a second end. The beam includes a top plate and a bottom plate opposite the top plate. A series of brace walls extend between the top plate and the bottom plate interior of the first and second side walls. A curb projection extends vertically above the top plate. The curb projection includes an outer face and an angled wall that joins the outer face at a curb tip. An intermediate bar extends between the outer face and the angled wall. A slot extends from the curb tip at least partially through the outer face and the angled wall in the direction of the intermediate bar.

### BRIEF DESCRIPTION OF THE DRAWINGS

The present disclosure is described with reference to the following Figures. The same numbers are used throughout the Figures to reference like features and components.

FIG. 1 is a cross-sectional view of an example of a beam extrusion.

FIG. 2 is an exploded view of a ramp.

FIG. 3 depicts an example of a beam integrated with a curb.

FIG. 4 is a detailed view of an exemplary central portion of a curb.

FIG. 5 depicts an example of a wheel riser.

### DETAILED DISCLOSURE

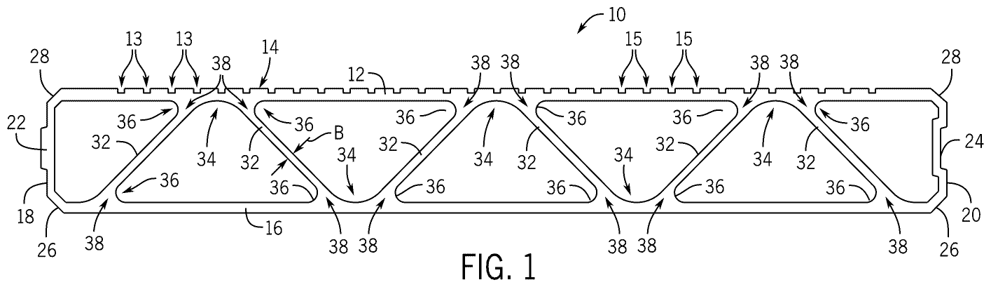

FIG. 1 is a cross-sectional view of an example of a beam 10 as described herein, from which a ramp may be constructed. In examples, the beam 10 may be constructed of extruded aluminum. However, in the present disclosure portions of the beam 10 are described as individual components for clarity purposes, and it will be recognized that such beam may be constructed by way of extrusion or using other manners of construction including assembly of separate pieces of various components shown and described using welding, adhesive, or other fastening techniques.

The beam 10 includes a top plate 12 which may include a textured surface 14. The textured surface 14 is depicted as a series of grooves 13 respectively separating a plurality of ridges 15, although the textured surface may also be machined, punched, or chemically etched into the top plate 12, or may be ribs, protrusions, or other shaped plates or pieces either extruded or welded, adhered, or otherwise fastened to the top plate 12. In still further examples, an acrylic, epoxy, or polymer which adheres to the textured surface 14 and may also incorporate grit therein.

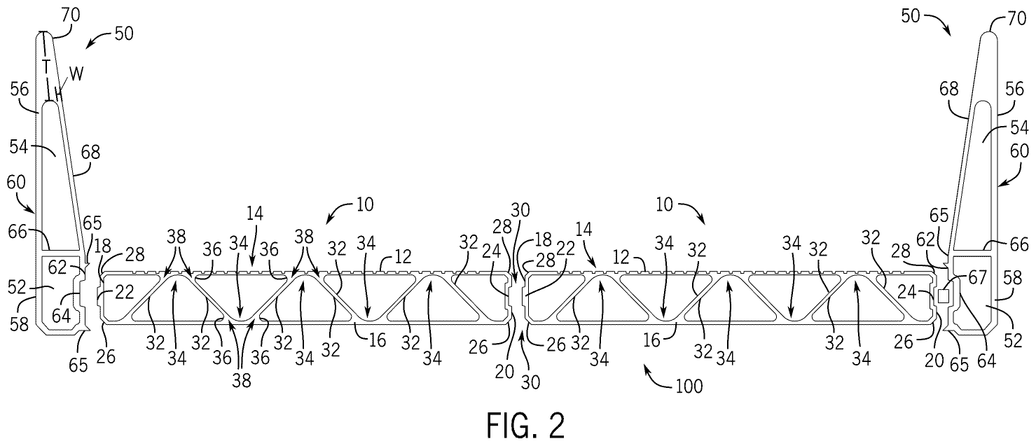

The beam 10 further includes a bottom plate 16. Opposed side walls 18, 20 extend between respective outer ends of the top plate 12 and the bottom plate 16. The opposed side walls 18, 20 include a tongue wall 18 with a tongue 22 extending outward therefrom and a grooved wall 20, with a groove 24 defined therein. FIG. 2 is an exploded view of one example of a construction of a ramp 100 as described herein. As shown in FIG. 2, two or more beams 10 can be secured side-by-side to form a ramp which includes the interlocking of a tongue 22 of one beam with a groove 24 of an adjacent beam. In examples, the tongue 22 is received in the groove 24 which aligns the adjacent beams 10 for assembly, which may further include welding the beams 10 together. Even once assembled, the interface between the tongue 22 and the groove 24 transfers load between the adjacent beams to improve overall strength of the assembled ramp and resists twist between the adjacent beams 10.

The side walls 18, 20 respectively join the top plate 12 and the bottom plate 16 with chamfered corners, for example, a lower chamfered corner 26 between a side wall 18, 20 and the bottom plate 16 and an upper chamfered corner 28 between a side wall 18, 20 and the top plate 12. Chamfered corners 26, 28 of adjacent beams align to form a depression 30 which is exemplarily constructed to contain a weld bead (not depicted) between the adjacent beams 10 and the depression 30 creates additional surface area for the welded connection between the adjacent beams 10.

The beam 10 includes a plurality of brace walls 32 which extend between the bottom plate 16 and the top plate 12. In an example, the brace walls 32 form a series of right triangles through the beam 10. The brace walls 32 each form a 45 degree angle with the top plate 12 and the bottom plate 16, the complementary angle between the two 45 degree angles being the 90 degree interior angle of the triangle formed by the two adjacent brace walls 32. The top plate 12 and the bottom plate 16 form the hypotenuses of the right triangles formed by the brace walls 32. In examples, because the angles are fixed, the length of the brace walls 32 and the respective hypotenuses depend upon the height of the side walls 18, 20. In examples, brace walls 32 may meet with the a side wall 18, 20 and a respective top plate 12 or bottom plate 16 at an interior side of chamfered corners 26, 28, or may intersect a top plate 12, bottom plate 16, or side wall 18, 20 individually. FIG. 1 exemplarily, and non-limitingly, depicts the brace wall 32 at either end of the beam 10 as intersecting the bottom plate 16 individually, with no exteriorly subsequent brace wall 32 extending therefrom.

The interior corners of the angles formed by the brace walls 32 are further reinforced and rounded. The 90 degree corners form arches 34 at respective interfaces with the top plate 12 and the bottom plate 16. These arches 34 similarly extend through 90 degrees of arc between the adjacent brace walls 32 and provide enhanced strength to support a load placed on the top plate 12 of the beam 10. The 45 degree corners form arcs 36. These arcs 36 similarly extend through 45 degrees of arc between the respective brace wall 32 and a respective one of the top plate 12 or bottom plate 16. The arches 34 and/or the arcs 36 form an area 38 of extended physical connection between the brace walls 32 and the respective top plate 12 and/or bottom plate 16. Area 38 is exemplarily at least 100% and exemplarily between 100%-300% of additional surface area connection between each brace wall and the respective top plate 12 and/or bottom plate 16 as compared to a nominal thickness B of the brace wall 32. The increased surface area connection between the supportive structures of the brace walls 32 and the top and bottom plates 12, 16, further improves the strength of the beam.

As noted previously, FIG. 2 depicts an exploded view of an example of a ramp 100 constructed of the beams 10 described above. While a ramp 100 may be constructed with one or more beams 10, as shown in FIG. 2, the ramp 100 may also include one or more curb rails 50. The curb rails 50 are adapted to be secured to beams 10 to form a curbed ramp. The curb rails 50 are exemplarily constructed as extrusions as are the beams 10, but it is also understood that the curb rails 50 may be constructed in other manners by assembly of components as well.

The curb rail 50 includes a rail body 52 and a curb projection 54 extending therefrom. The curb projection 54 extends vertically above the top plate 12 of an adjacent beam 10. The curb projection 54 has an outer face 56 that is flush with an outer face 58 of the rail body 52 to form an exterior wall 60 of the curb rail 50. In an example, the exterior wall 60 is continuous between the outer face 56 and the outer face 58 such that any transition between the outer face 56 and the outer face 58 is not visible upon viewing the exterior wall 60 and there is no weld or seam between the outer face 56 and the outer face 58 at the exterior wall 60.

The rail body 52 further includes an interior face 62 between two projections 65. The projections 65 are exemplarily triangular in shape and dimensioned to complementarily match the lower chamfered corner 26 and the upper chamfered corner 28 of the beam 10. The projections 65 are received within the respective lower chamfered corner 26 and upper chamfered corner 28. This may serve the function of centering and aligning a side wall 18, 20 of the beam and the interior face 62 of the curb rail 50. After alignment, the curb rail 50 may be secured to the beam 10 by welding along the respective interfaces between projections 65 and the chamfered corners 26, 28. The interior face 62 may further include a groove 64 which is exemplarily the same as the groove 24 in the beam 10. The groove 64 is thus similarly dimensioned to receive a tongue 22 of the beam 10, as shown on the left hand side of FIG. 2, while on the right hand side, the groove 64 does not impede interfacing contact between the interior face 62 of the curb rail 50 and the exterior of the grooved side wall 20 of the beam 10. In an optional and non-limiting example, filler body 67, for example, a bar, rail, or spacer may be positioned within the space formed by facing grooves 24, 64 for additional rigidity between the beam 10 and the curb rail 50.

The rail body 52 of the curb rail 50 further includes an intermediate bar 66 between the interior face 62 and the outer face 58. The intermediate bar 66 further defines the separation between the rail body 52 and the curb projection 54. The curb projection further includes an angled wall 68 that angles outward from the intermediate bar 66 to a curb tip 70 where the angled wall 68 meets the outer face 56. The curb tip 70 is exemplarily rounded to form the transition between the angled wall 68 and the outer face 56. The curb tip 70 is exemplarily solid, the thickness “T” of the metal at the curb tip 70 being significantly greater that the nominal thickness “W” of the rest of the walls of the curb rail 50. In an example, T>4W, while in other examples, T>10W. The thickness “T” may exemplarily represent at least 20%, 25%, or 30% of the total vertical distance of the curb projection 54.

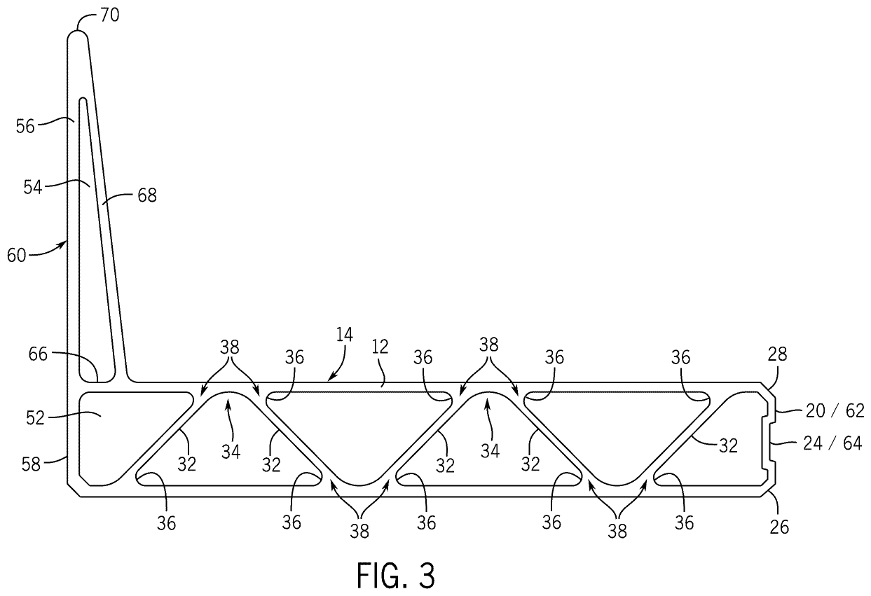

FIG. 3 depicts a further example of an integrated curb rail 50 and beam 10. The integrated curb rail 50 and beam 10 may be used in combination with one or more additional beams 10 to form a ramp. As shown in FIG. 3, the curb projection 54 extends vertically above the top plate 12. A similar structure of brace walls 32 extend between the top plate 12 and the bottom plate 16, as described above with respect to FIG. 2. The side wall 20 includes chamfered corners 26, 28 and a groove 24/64 set therein to facilitate connection to an adjacent beam 10 (FIGS. 1, 2) to form a ramp.

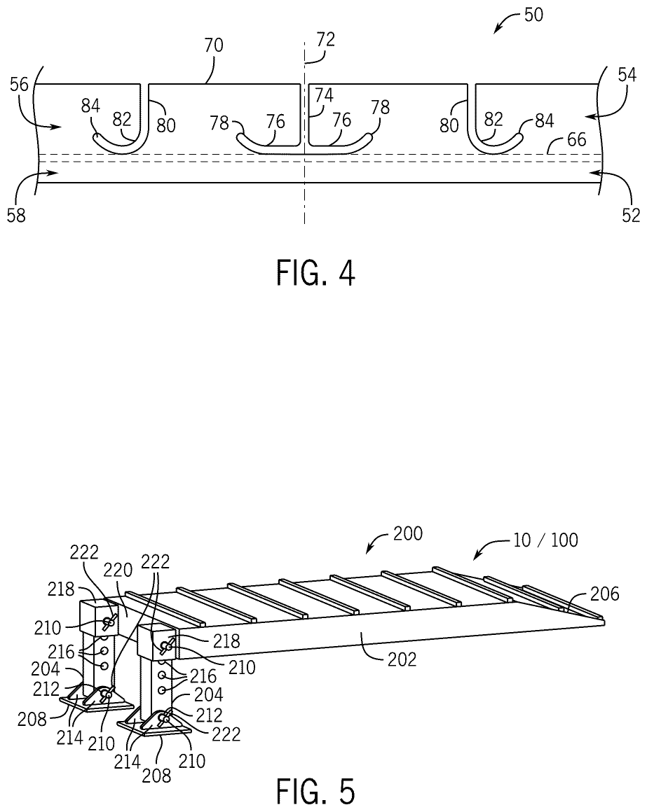

FIG. 4 is a detailed view of an exemplary central portion along a length of a curb rail 50. It will be recognized that the curb rail 50 may exemplarily be of the configuration as depicted in FIG. 2 or as depicted in FIG. 3. Additionally, the curb rail may be of any of a variety of other configurations as will be recognized by a person of ordinary skill in the art in view of the present disclosure, including but not limited to ramps as described in U.S. Pat. No. 10,710,824 It will be recognized that FIGS. 2 and 3 exemplarily present an end views of exemplary curb rails 50, while FIG. 4 is a portion of a side view of an example of a curb rail 50. The inventors have discovered that when a ramp constructed with curbs is placed under load, this load causes bending along the length of the curb can cause excessive stress and weakness in the curb. The load on the top surface of the ramp places the curb projection 54 into compression. It has been discovered that compression relief, as disclosed herein, in the curb projection 54 improves durability of the ramp.

A midline 72 represents the center in the lengthwise dimension of the curb rail 50. At the midline 72, a medial relief slot 74 extends through the curb projection from the curb tip 70 in a direction of the intermediate bar 66, and exemplarily to the intermediate bar 66, represented by the dashed line. It will be recognized that at least in some examples, the slots described herein may extend through the entire curb projection 54, including, but not limited to the curb tip 70, the outer face 56 and the angled wall 68. Exemplarily, but not limitingly, the medial relief slot 74 extends from the curb tip 70 all the way to the intermediate bar 66. At the intermediate bar 66, transverse slots 76 extend away from the medial relief slot 74 in either direction along the intermediate bar 66. Return slots 78 extend from the transverse slots 76, angling away from the medial relief slot 74 and the intermediate bar 66 towards the curb tip 70, while stopping well short thereof. In examples, the return slots 78 may be on a radius as opposed to strictly linear angle away from the transverse slot 76. In examples, the medial relief slot 74, transverse slots, and return slots 78 may be 0.5″ or less, 0.375″ or less, or 0.25″ or less.

Lateral relief slots 80 are spaced between the midline 72 and respective lateral ends (not shown) of the curb rail 50. The lateral relief slots 80 extend from the curb tip 70 towards the intermediate bar 66. The lateral relief slot 80 transitions to arcing slot 82 in the direction away from the midline 72, and which exemplarily reaches a maximum depth at the intermediate bar 66. After reaching the intermediate bar 66, return slots 84, which may be similar in construction to return slots 78 angle away from the intermediate bar 66 and the midline 72. In examples, the lateral relief slot 80, arcing slot 82, and return slots 84 may be 0.5″ or less, 0.375″ or less, or 0.25″ or less.

FIG. 5 depicts an example of a wheel riser 200 exemplarily constructed from one or more beams 10 as previously described. It will be recognized that the wheel riser may also be similarly constructed using a combination load leveler and ramp, for example as previously described in US2022/0017314. The wheel riser 200 includes a ramp which may be constructed by beams 10 and/or a load leveler 202. Legs 204 are removably mounted at an end 220 opposite a transition or foot 206. The legs 204 are exemplarily constructed of extruded box tubing. The legs 204 are pivotably attached to feet 208 with a handled pivot pin 210. The handled pivot pin 210 extends through holes 212 in a pivot frame 214 of a foot 208. The legs 204 exemplarily include a plurality of regularly spaced apart adjustment holes 216. The handled pivot pin 210 extends through adjustment holes 216 in the legs 204 to pivotably secure the foot 208 to the leg 204. Once secured, the pivot pin 210 may further be secured by a locking pin 222 therethrough. Leg shrouds 218 are welded to the end 220 of the ramp/load leveler 202. The legs 204 are removably received within the leg shrouds 218 and the leg shrouds 218 are able to translate along the legs 204. The leg shroud 218 is secured to the leg 204, for example, with a handled pivot pin 210 through the leg shroud 218 and a set of adjustment holes 216 of the leg 204. Locking pins 222 may further secure the handled pivot pins 210 in place.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives and modifications are possible within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A ramp, the ramp comprising:
an extruded beam extending between a first end and a second end, the extruded beam having:
a top plate;
a bottom plate opposite the top plate;
a first side wall and a second side wall that each extend between the top plate and the bottom plate;
a series of alternately angled brace walls with adjacent brace walls of the series form a plurality of right triangles between the top plate and the bottom plate interior of the first and second side walls.

2. The ramp of claim 1, wherein the first side wall comprises a tongue extending lengthwise along the first side wall and outwardly away from the second side wall and the second side wall comprises a groove extending lengthwise along the second side wall and interiorly towards the first side wall.

3. The ramp of claim 2, wherein the tongue is of a first dimension configured to fit within a second dimension of the groove.

4. The ramp of claim 1, further comprising an arch formed between each adjacent brace wall at respective intersections of the adjacent brace walls and the top plate or the bottom plate.

5. The ramp of claim 4 wherein the arch is through 90° of arc.

6. The ramp of claim 1, further comprising an arc between each of the brace walls and the top plate or the bottom plate, wherein the arc forms an extended area of physical connection between the brace walls and the respective first or second plate.

7. The ramp of claim 6, wherein the arc is through 45° of arc.

8. The ramp of claim 1, further comprising a curb projection extending vertically above the top plate.

9. The ramp of claim 8, further comprising a curb rail comprising a rail body and the curb projection extending from the rail body, the rail body comprising an interior face opposite an outer face of the rail body, wherein the interior face is configured for engagement with the first or second side wall of the extruded beam.

10. The ramp of claim 9, wherein the rail body further comprises a first projection and a second projection extending outward from the rail body in a direction away from the outer face, the interior face being defined between the first and second projections, wherein the interior face, first projection, and second projection are configured for engagement with the extruded beam.

11. The ramp of claim 10, further comprising:
first chamfered corners where the top plate meets the first side wall and the second side wall; and
second chamfered corners where the bottom plate meets the first side wall and the second side wall;
wherein the first projection is configured to correspond to the first chamfered corners and the second projection is configured to correspond to the second chamfered corners.

12. The ramp of claim 11, wherein the extruded beam is a first extruded beam and further comprising a second extruded beam and wherein the first chamfered corners of the first and second extruded beams are configured to form a first depression between the first extruded beam and the second extruded beam, and wherein the second chamfered corners of the first and second extruded beams are configured to form a second depression between the first extruded beam and the second extruded beam.

13. The ramp of claim 11, further comprising:
a first groove extending lengthwise along the interior face of the rail body;
wherein the first side wall comprises a tongue extending lengthwise along the first side wall and outwardly away from the second side wall;
wherein the second side wall comprises a second groove extending lengthwise along the second side wall and interiorly towards the first side wall; and
wherein the first groove is configured to receive the tongue of the first side wall.

14. The ramp of claim 8, wherein the curb projection is integral to the extruded beam.

15. The ramp of claim 8, wherein the curb projection comprises an outer face and an angled wall that joins the outer face at a curb tip and further comprising a slot that extends from the curb tip at least partially through the outer face and the angled wall.

16. The ramp of claim 15, wherein the slot is a medial slot along a midline of the curb projection and further comprising at least one lateral slot that extends from the curb tip at least partially through the outer face and the angled wall at a location between the midline and a lateral end of the curb projection.

17. The ramp of claim 15, further comprising:
an intermediate bar that extends between the outer face and the angled wall, wherein the slot extends from the curb tip in a direction of the intermediate bar.

18. The ramp of claim 17 further comprising:
an arcing slot that extends from the slot in a direction away from a midline and towards the intermediate bar; and
a return slot that extends from the arcing slot in the direction away from the midline and towards the curb tip.

19. The ramp of claim 17, further comprising:
a transverse slot that extends perpendicularly away from the slot; and
a return slot that extends from the transverse slot in a direction away from a midline and towards the curb tip.

20. A ramp, the ramp comprising:
a beam extending between a first end and a second end, the beam having:
a top plate;
a bottom plate opposite the top plate;
a first side wall and a second side wall; and
a series of brace walls extending between the top plate and the bottom plate interior of the first and second side walls; and
a curb projection extending vertically above the top plate, the curb projection comprising:
an outer face;
an angled wall that joins the outer face at a curb tip;
an intermediate bar that extends between the outer face and the angled wall; and
a slot that extends from the curb tip at least partially through the outer face and the angled wall in a direction of the intermediate bar.
